(19) United States
(12) Patent Application Publication
(10) Pub. No.: US 2017/0168465 A1
(43) Pub. Date: Jun. 15, 2017

(54) INFORMATION PROCESSING METHOD AND WEARABLE DEVICE

(71) Applicant: Lenovo (Beijing) Limited, Beijing (CN)

(72) Inventor: Xingwen Chen, Beijing (CN)

(21) Appl. No.: 15/378,026

(22) Filed: Dec. 13, 2016

(30) Foreign Application Priority Data
Dec. 14, 2015 (CN) 201510926602.4

(51) Int. Cl. G05B 13/02; G06F 1/16

(52) U.S. Cl. CPC G05B 13/0205; G06F 1/163

(57) ABSTRACT

Disclosed is an information processing method, including, but not limited to, detecting a first wearing position of a wearable device worn on the body of a user, wherein the wearable device provides one or more first functions corresponding to the first wearing position as well as one or more second functions corresponding to a different second wearing position of the wearable device on the body of the user; determining the one or more first functions of the wearable device corresponding to the first wearing position based on the first wearing position; and activating at least one of the first functions of the wearable device in response to detecting the wearable device is worn in the first wearing position.

### CLAIM FOR PRIORITY

This application claims priority to Chinese Application No. 201510926602.4, filed on Dec. 14, 2015, the contents of which are fully incorporated by reference herein.

### TECHNICAL FIELD

The subject matter relates to the field of electronic technologies, and in particular, to an information processing method and a wearable device.

### BACKGROUND

With the continuous development of science and technology, various electronic devices such as smart shoes, smart wristbands and smart watches are constantly updated to have enriched functions, thereby bringing great convenience to people's life and work.

In the prior art, a smart device can only meet requirements for a single scenario. For example, a smart wristband is worn on a hand for measuring heartbeats, smart shoes implement the function of step counting, and so on. However, during actual use, a user needs to measure heartbeats, count steps and so on in one day. As a result, the user needs to carry different smart devices, making it inconvenient for the user.

### BRIEF SUMMARY

In summary, one aspect provides a method, comprising: detecting a first wearing position of a wearable device worn on the body of a user, wherein the wearable device provides one or more first functions corresponding to the first wearing position as well as one or more second functions corresponding to a different second wearing position of the wearable device on the body of the user; determining the one or more first functions of the wearable device corresponding to the first wearing position based on the first wearing position; and activating at least one of the first functions of the wearable device in response to detecting the wearable device is worn in the first wearing position.

Another aspect provides a wearable device, comprising: a casing; a sensor, disposed in the casing; and a processor, disposed in the casing and connected to the sensor, wherein the processor: detects a first wearing position of the wearable device worn on the body of a user, wherein the wearable device provides one or more first functions corresponding to the first wearing position as well as one or more second functions corresponding to a different second wearing position of the wearable device on the body of the user; determines the one or more first functions corresponding to the first wearing position based on the first wearing position; and activates at least one of the first functions of the wearable device in response to the first wearing position being detected.

A further aspect provides a method, comprising: detecting a first wearing position of a wearable device from among a plurality of predetermined wearing position settings of the wearable device, wherein the wearable device provides one or more first functions corresponding to the first wearing position as well as one or more second functions corresponding to a different second wearing position of the wearable device on the body of the user; activating, using a processor of the wearable device, the one or more first functions in response to the first wearing position being detected; detecting the second wearing position of the wearable device from among the plurality of predetermined wearing position settings of the wearable device; and changing, using the processor the wearable device, at least one of first functions to at least one of the second functions in response to the second wearing position being detected.

The foregoing is a summary and thus may contain simplifications, generalizations, and omissions of detail; consequently, those skilled in the art will appreciate that the summary is illustrative only and is not intended to be in any way limiting.

For a better understanding of embodiments, together with other and further features and advantages thereof, reference is made to the following description, taken in conjunction with the accompanying drawings, and the scope of the invention will be pointed out in the appended claims.

### BRIEF DESCRIPTION OF THE SEVERAL VIEWS OF THE DRAWINGS

FIG. 1 illustrates an example information processing method.

FIG. 2 is a schematic diagram of an example embodiment.

FIG. 3 is a structural diagram of an example electronic device according to an embodiment.

### DETAILED DESCRIPTION

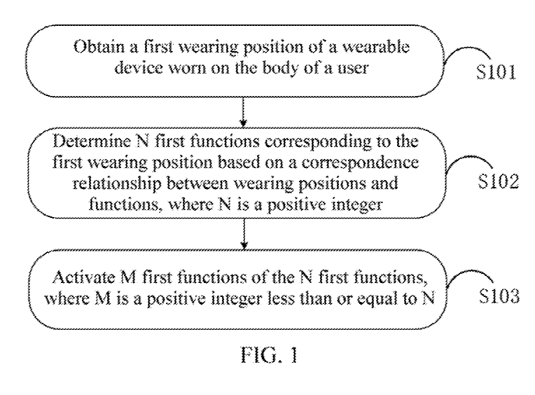

It will be readily understood that the components of the embodiments, as generally described and illustrated in the figures herein, may be arranged and designed in a wide variety of different configurations. Thus, the following more detailed description of the embodiments of the apparatus, system, and method of the present invention, as represented in FIGS. 1 through 3 is not intended to limit the scope of the embodiments, as claimed, but is merely representative of selected embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. In the following description, numerous specific details are provided, to provide a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

An information processing method in accordance with an embodiment provides a method comprising: obtaining a first wearing position of a wearable device worn on the body of a user; determining N first functions corresponding to the first wearing position based on a corresponding relationship between wearing positions and functions, where N is a positive integer; and activating M first functions of the N first functions, where M is a positive integer less than or equal to N.

### Example Embodiment I

An information processing method may be applied to a wearable device. The wearable device may be a smart accessory worn on a first electronic device, for example, a smart shoe, a smart watch or a smart bag, or any other smart accessory worn on an electronic device.

Referring to FIG. 1, an embodiment provides an information processing method. At S101, a first wearing position of a wearable device worn on the body of user is obtained. At S102, N first functions corresponding to the first wearing position based on a corresponding relationship between wearing positions and functions, where N is a positive integer, are determined. At S103, M first functions of the N first functions, where M is a positive integer less than or equal to N, are activated.

Step S101 comprises acquiring at least one sensor parameter through a sensor in the wearable device and analyzing the at least one sensor parameter to obtain the first wearing position of the wearable device worn on the body of the user. Different sensor parameters may be obtained according to combinations of different sensors and a wearing position of the wearable device is determined based on the acquired sensor parameters. The sensor in the wearable device may be a pressure sensor, a proximity sensor, a gravity sensor, an angle sensor, a light sensor, or any other sensors in a wearable device.

After the at least one sensor parameter is acquired through the sensor, the current wearing position of the wearable device may be determined by analyzing a relative position, for example, the height and the angle, and analyzing a motion parameter, for example, an acceleration parameter, in a space or acquired light intensity.

In one non-limiting example, if the distance, acquired through a proximity sensor, from the wearable device to a reference plane is 10 cm; the angle, detected through a gravity sensor, between the wearable device and a reference plane is 0 degrees, and the direction in which the pressure is applied is a vertical direction; and an acceleration parameter is obtained through an acceleration sensor, it may be determined based on the foregoing analysis principle that the application scenario of the wearable device is: wearing on a user's smart shoe.

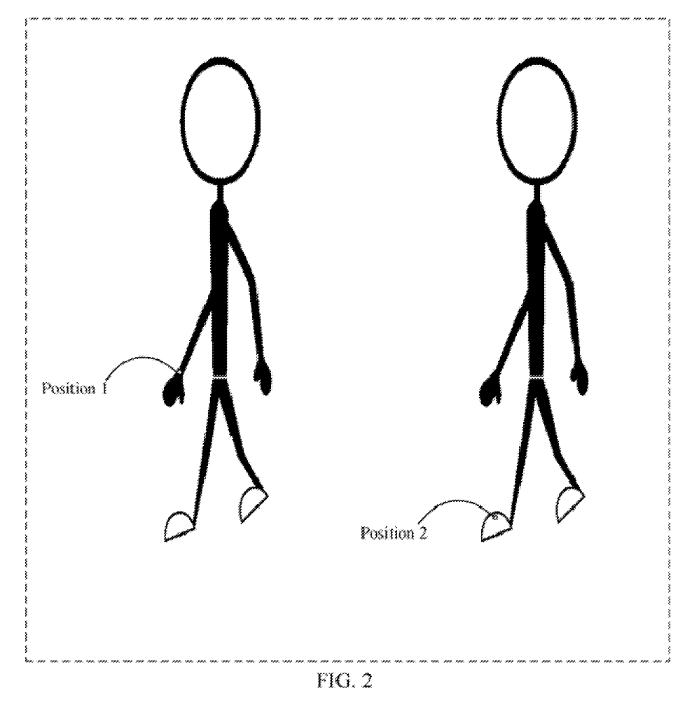

In another non-limiting example, if the distance from the wearable device to a reference plane is 1.6 m; the angle, detected through a gravity sensor, between the wearable device and a reference plane is 90 degrees; and the light intensity, acquired through a light sensor, of the current environment of the wearable device is 10 cd, which is lower than a preset light intensity, it may be determined based on the foregoing analysis principle that the application scenario of the wearable device is: wearing in a pocket of the user's shirt. Reference can be made to position 2 and position 1 in FIG. 2 for example details.

The reference plane may be the ground on which the wearable device currently stands or a certain part, for example, eyes or shoulders, on the body of the user on which the wearable device is worn. Those skilled in the art will appreciate the various methods for setting the desired reference plane.

Multiple functions may be integrated in the wearable device to enable different functions in different scenarios. In an embodiment, a correspondence between wearing positions and functions may be preset, so that after a wearing position of the wearable device is determined, functions corresponding to the wearing position may be determined from a relational table of wearing positions and functions.

In one non-limiting example, when the wearable device is worn on the shoe, it may be determined based on the correspondence between the wearing positions and the functions that the wearable device implements the functions of step counting, motion state detection, posture/gait detection, adaptive lighting effect and so on. When the wearable device is worn in the pocket of the shirt, it may be determined based on the correspondence between the wearing positions and the functions that the wearable device implements the functions of step counting, motion detection, and detection of body swinging, shaking, leaning left and right and so on. When the wearable device is worn on the wrist, it may be determined based on the correspondence between the wearing positions and the functions that the wearable device mainly implements the functions of step counting, motion detection, arm swinging, pulse and so on.

Obtaining a first wearing position of a wearable device worn on the body of a user may comprise: determining a first working frequency corresponding to the first wearing position based on a corresponding relationship between wearing positions and working frequencies of a processor of the wearable device and adjusting a working frequency of the processor to the first working frequency.

When the wearable device is at different wearing positions, corresponding functions to be implemented may also be different, and when the implemented functions are different, requirements for a working frequency of a processor of the wearable device may also be different. In one non-limiting example, when the wearable device is worn on a shoe, functions such as step counting, motion state detection, posture/gait detection, adaptive lighting effects need to be implemented, many functions are to be processed, and implementation processes are complex. Therefore the requirement for the working frequency of the processor is high, for example, 1 GHz. When the wearable device is worn in the pocket of the shirt, the wearable device may only need to implement a step counting function, therefore, compared to wearing it on the shoe, fewer and simpler functions are implemented, and the requirement for the working frequency of the processor is lower, for example, 512 MHz.

In order to prevent the wearable device from always working at a high working frequency, the working frequency of the processor corresponding to a wearing position may be determined in real time according to the wearing position, thereby achieving the technical effect of reducing power consumption of the wearable device.

When the wearing position of the wearable device is determined to be the first wearing position, namely, the shoe, the working frequency corresponding to the first wearing position may be determined to be a first working frequency, e.g., 1 GHz, and then when it is detected that the working frequency of the processor of the wearable device is not 1 GHz (for example, lower than 1 GHz or higher than 1 GHz), the working frequency of the processor may be adjusted.

After the wearing position of the wearable device is determined, the working frequency of the processor may further be adjusted based on how many functions are to finally be implemented at the wearing position. In one non-limiting example, there may be five functions corresponding to the first wearing position. Embodiments provide that when all five functions are implemented, the working frequency of the processor needs to be 1 GHz, and when only three functions of the five functions are performed, the working frequency of the processor may be adjusted from 1 GHz to 512 MHz, so as to further reduce power consumption of the wearable device and increase standby time of the wearable device, thereby achieving the technical effect of improving user experience.

After obtaining a first wearing position of a wearable device worn on the body of a user, a method may further include determining at least one sensor corresponding to the first wearing position from all sensors of the wearable device and controlling the at least one sensor to be in a working state and controlling sensors other than the at least one sensor to be in a non-working state.

When the wearable device is at different wearing positions, corresponding functions to be implemented may be different, and when different functions are implemented, types of sensors needed may also be different. In one non-limiting example, when the wearable device is worn on the shoe, in order to implement step counting, motion state detection, posture/gait detection, and adaptive lighting effect, a 9-axis sensor, a pressure sensor, a light sensor and so on are needed. When the wearable device is worn in the pocket of the shirt, in order to implement step counting, motion detection, body swinging, shaking, and leaning left and right, only a 3-axis sensor may be needed.

To prevent having all sensors in the wearable device be in a working state, sensors corresponding to a wearing position may be determined in real time according to the wearing position, so as to control the working state of the sensor, thereby achieving the technical effect of reducing power consumption of the electronic device.

In one non-limiting example, when the wearing position of the wearable device is determined to be the first wearing position, namely, the shoe, sensors corresponding to the first wearing position may be determined to be a 9-axis sensor, a pressure sensor, and a light sensor, and after the sensors corresponding to the first wearing position are determined, the sensors corresponding to the first wearing position may be enabled and other sensors may be disabled, so as to reduce power consumption of the wearable device.

Besides the working states of the sensors, a working state of a functional component in the wearable device also may need to be controlled. In one non-limiting example, when the wearing position is the shoe, in order to implement the function of an adaptive lighting effect, the whole LED lamp naturally may need to be enabled, and when the wearing position is the pocket of the shirt, the function of an adaptive lighting effect may not need to be implemented, and accordingly, the LED lamp needs to be disabled, so as to reduce power consumption of the wearable device.

After obtaining a first wearing position of a wearable device worn on the body of a user, a method may further include determining, based on a corresponding relationship between wearing positions and interaction instruction sets, that a current interaction instruction set of the wearable device is a first interaction instruction set corresponding to the first wearing position, where the interaction instruction set comprises at least one input operation and at least one corresponding response instruction.

In order to conform to usage habits of the user and operation habits on the wearable device at different positions and provide the user with a desirable experience, an interaction instruction set corresponding to a wearing position may be determined according to a correspondence between wearing positions and interaction instruction sets.

When the wearable device is at different wearing positions, interaction modes of the user of the wearable device and the wearable device may be different. In one non-limiting example, when the wearable device is worn on the shoe, the user performs control mainly by action recognition, for example, stamping with one foot, stamping continuously with one foot, stamping around with one foot, turning around or other convenient control methods. When the wearable device is worn in the pocket of the shirt, the user may control the wearable device through keys or body actions such as leaning forward or swaying left and right.

When the wearable device is worn at different positions in the same part on the body of the user, there may be different requirements for the interaction mode of the wearable device. In one non-limiting example, when the wearable device is worn in a left pocket and a right pocket of the shirt, positions with convenient user operation may also be different, because when the wearable device is worn in the pocket of the shirt of the user, the user usually controls the wearable device through a key, and when the wearable device is worn in the right pocket of the shirt, it is easy for the user to operate a key on the left side, while when the wearable device is worn in the left pocket of the shirt, it is easy for the user to operate a key on the right side. Keys may be set on both the left side and the right side of the wearable device, and when the wearable device is worn on the left side, the key on the right side may be enabled, and the key on the left side may be disabled; when the wearable device is worn on the right side, the key on the left side may be enabled, and the key on the right side may be disabled. Thus, the user can be provided with a better experience.

After obtaining a first wearing position of a wearable device worn on the body of a user, a method may further include determining a first display mode corresponding to the first wearing position based on a correspondence relationship between wearing positions and display modes, where the display mode comprises a display mode of the wearable device and/or a display mode of the first electronic device connected to the wearable device.

In order to meet user requirements for the viewing effect in different scenarios and provide the user with a desirable experience, a display mode corresponding to a wearing position may be determined based on a corresponding relationship between wearing positions and display modes.

When the wearable device is worn on the shoe, the wearable device may need to implement functions such as step counting, motion state detection, posture/gait detection, and adaptive lighting effect, and then function icons, for example, a step counting icon, an icon for detecting a motion state, an icon for controlling LED flickering and so on, corresponding implemented functions are displayed on a display unit of the wearable device or the first electronic device. When the wearable device is worn in the pocket of the shirt, the wearable device may need to implement functions such as step counting, motion detection, body swinging, shaking, and leaning left and right, and then function icons, for example, a step counting icon, an icon for measuring body swinging or shaking and so on. Corresponding functions may be displayed on the display unit of the wearable device and/or the first electronic device so as to meet different user requirements and provide the user with a desirable experience.

The display mode may not only include displaying function ions corresponding to different functions, but may also include adjusting a display area of display content on the display unit. In one non-limiting example, when the wearable device is worn on the left wrist of the user, because the left side of the display unit may be easily blocked by clothing, the display content may be displayed in a display area on the right side. When the wearable device is worn on the right wrist of the user, because the right side of the display unit is easily blocked by clothing, the display content may be displayed in a display area on the left side so as to facilitate viewing of the user.

The display mode may further comprise adjusting a display size of the display content. In one non-limiting example, when the wearable device is worn on the shoe, because the shoe is far away from the user's eyes, under the condition that the user has poor eyesight, it would be difficult for the user to see the content displayed on the display unit, in this case, the display size of the display content would need to be increased to make it more convenient for the user to see. When the wearable device is worn on the wrist, the user can view the wearable device easily. In this case, the display size of the display content may be made small to display more content so as to meet different user requirements.

In order to reduce power consumption of the wearable device, all functions in the wearable device may be placed in the OFF state and may enter an ON state only when entering a corresponding application scenario. N functions may need to be activated after N first functions corresponding to the first wearing position are determined. In one non-limiting example, five functions are determined to correspond to the first wearing position, but the user may only want to implement three of the five functions and the other two do not need to be implemented, or the battery level of the wearable device may be low and insufficient to support implementation of all functions, and only three functions may be implemented. In this non-limiting example, M functions of the N functions may be activated.

While activating M first functions of the N first functions, a method may further include disabling controlling functions other than the N first functions in the wearable device. While the M first functions of the N first functions are activated, in order to reduce power consumption of the wearable device, functions other than the N first functions may be disabled so as to increase standby time of the wearable device and provide the user with a better experience.

After activating M first functions of the N first functions, a method may further comprise performing the M first functions and requesting a first electronic device connected to the wearable device to perform a processing procedure corresponding to the M functions.

After the M functions of the N first functions are activated and the M first functions are performed, a first electronic device connected to the wearable device is requested to perform a processing procedure corresponding to the M functions. In one non-limiting example, when the first wearing position is the shoe, functions corresponding to the first wearing position may be step counting, step counting implementation, motion state detection, and posture/gait detection, and then, after the functions are performed, the first electronic device may display a step counting result, a motion state detection result and a posture on a display unit or may present them to the user through a voice unit, or may present them to the user in any other suitable means of communication.

While activating M first functions of the N first functions, a method may further comprise determining a first processing mode corresponding to each first function of the M first functions, where the first processing mode comprises an input parameter and a processing procedure corresponding to the first processing mode, wherein performing the first function comprises receiving the input parameter corresponding to the first processing mode and performing preset processing corresponding to the first processing mode on the input parameter, and then outputting the input parameter.

Two non-limiting example methods for determining the first processing mode of each first function are described herein.

First Situation

When wearing positions of the wearable device are different, corresponding functions to be performed may also be different. In one non-limiting example, at the first wearing position, functions A and B may be performed. At a second wearing position, functions C and D may be performed, wherein functions A and B may be completely different from functions C and D. Then, when the wearable device is moved from the first wearing position to the second wearing position, functional algorithms corresponding to functions C and D may be immediately invoked.

Second Situation

When wearing positions of the wearable device are different, the same function is to be performed, but specific implementation algorithms of the same function may be different. In one non-limiting example, when both the wearable device is worn on the wrist of the user and the wearable device is worn on the shoe of the user, a step counting function may be performed, and when the wearable device is worn on the wrist, the sampling frequency is A in order to ensure precision of step counting, while when the wearable device is worn on the shoe of the user, the precision of step counting may be affected due to the change of the application scenario. As a result, the sampling frequency may need to be increased to B to ensure the same precision as wearing it on the wrist. Therefore, when the wearable device is moved from the first wearing position to the second wearing position, and the step counting function is to be implemented, a corresponding step counting algorithm may be adjusted to ensure the precision of step counting function

When the first function is a step counting function, acceleration parameters may be collected by an acceleration sensor in the wearable device and a step count may be determined by analyzing and processing the collected acceleration parameters. This is because during the process of walking, vertical acceleration and forward acceleration periodically change in level walking. In the action of getting the foot back during walking, the center of gravity moves upward and one foot touches the ground, so the vertical acceleration increases in the positive direction, and afterwards, when moving forward, the center of gravity moves downwards and two feet touch the ground, so the acceleration changes in the opposite way, while the horizontal acceleration decreases when getting the foot back and increases when stepping forward. The step count may be acquired according to the collected acceleration parameters based on the foregoing step counting principle.

### Embodiment II

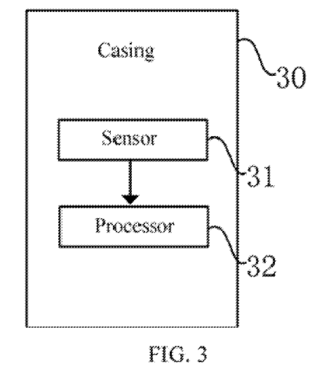

Referring to FIG. 3, a wearable device comprises: a casing 30; a sensor 31 disposed in the casing 30; and a processor 32 disposed in the casing 30 and connected to the sensor 31, and configured to obtain a first wearing position of the wearable device worn on the body of a user; determine N first functions corresponding to the first wearing position based on a correspondence relationship between wearing positions and functions, where N is a positive integer; and activate M first functions of the N first functions, where M is a positive integer less than or equal to N.

The processor 32 may acquire at least one sensor parameter through the sensor and analyze the at least one sensor parameter to obtain the first wearing position of the wearable device worn on the body of the user.

The processor 32 may, after activating M first functions of the N first functions, perform the M first functions, and request a first electronic device connected to the wearable device to perform a processing procedure corresponding to the M functions.

The processor 32 may, after obtaining a first wearing position of a wearable device worn on the body of a user, determine a first working frequency corresponding to the first wearing position based on a correspondence relationship between wearing positions and working frequencies of the processor of the wearable device; and adjust a working frequency of the processor to the first working frequency.

The processor 32 may, after obtaining a first wearing position of a wearable device worn on the body of a user, determine at least one sensor corresponding to the first wearing position from all sensors of the wearable device; and control the at least one sensor to be in a working state and control sensors other than the at least one sensor to be in a non-working state.

The processor 32 may, while activating M first functions of the N first functions, disable control functions other than the N first functions in the wearable device.

The processor 32 may, after obtaining a first wearing position of a wearable device worn on the body of a user, determine, based on a corresponding relationship between wearing positions and interaction instruction sets, that a current interaction instruction set of the wearable device is a first interaction instruction set corresponding to the first wearing position, where the interaction instruction may comprise at least one input operation and at least one corresponding response instruction.

The processor 32 may, after obtaining a first wearing position of a wearable device worn on the body of a user, determine a first display mode corresponding to the first wearing position based on a corresponding relationship between wearing positions and display modes, where the display mode comprises a display mode of the wearable device and/or a display mode of the first electronic device connected to the wearable device.

The processor 32 may, while activating M first functions of the N first functions, determine a first processing mode corresponding to each first function of the M first functions, where the first processing mode comprises an input parameter and a processing procedure corresponding to the first processing mode; receive the input parameter corresponding to the first processing mode; and perform preset processing corresponding to the first processing mode on the input parameter and then output the input parameter.

A technical solution of the embodiments includes: obtaining a first wearing position of a wearable device worn on the body of a user; determining N first functions corresponding to the first wearing position based on a correspondence relationship between wearing positions and functions, where N is a positive integer; and activating M first functions of the N first functions, where M is a positive integer less than or equal to N. Unlike the prior art in which a smart device can only meet requirements for a single scenario, so that a user needs to carry different smart devices to implement different functions, in this technical solution, a wearable device can meet different functional requirements in different application scenarios, so as to effectively solve the technical problem that a wearable device in the prior art cannot meet requirements for multiple scenarios, thereby achieving the technical effect of meeting requirements for multiple scenarios.

A technical solution of the embodiments includes: determining a first working frequency corresponding to the first wearing position based on a correspondence relationship between wearing positions and working frequencies of a processor of the wearable device; and adjusting a working frequency of the processor to the first working frequency. That is, in this technical solution, the working frequency of the wearable device can be adjusted according to an application scenario of the wearable device, so that the processor works at an appropriate working frequency, and the situation that the wearable device works at a high working frequency in any application scenario is avoided, thereby achieving the technical effect of reducing power consumption of the wearable device.

A technical solution of the embodiments includes: determining at least one sensor corresponding to the first wearing position from all sensors of the wearable device; and controlling the at least one sensor to be in a working state and controlling sensors other than the at least one sensor to be in a non-working state. That is, in this technical solution, working states of sensors in the wearable device are adjusted in real time according to an application scenario of the wearable device. That is, sensors corresponding to the scenario are controlled to be in a working state and other sensors are controlled to be in a non-working state so as to avoid the situation that all sensors in the wearable device remain in the working state in any application scenario, thereby achieving the technical effect of reducing power consumption of the wearable device.

A technical solution of the embodiments includes: determining, based on a correspondence relationship between wearing positions and interaction instruction sets, that a current interaction instruction set of the wearable device is a first interaction instruction set corresponding to the first wearing position, where the interaction instruction set includes at least one input operation and at least one corresponding response instruction. That is, in this technical solution, an interaction instruction set corresponding to the first wearing position can be determined according to a correspondence between wearing positions and interaction instruction sets, and because the current interaction instruction set is an interaction instruction set corresponding to the first wearing position, user requirements of the wearable device can be better met, thereby achieving the technical effect of improving user experience.

A technical solution of the embodiments of the application includes: determining a first display mode corresponding to the first wearing position based on a correspondence relationship between wearing positions and display modes, where the display mode includes a display mode of the wearable device and/or a display mode of a first electronic device connected to the wearable device. That is, in this technical solution, a first display mode corresponding to the first wearing position can be determined according to a correspondence between wearing positions and display modes, and because the first display mode is a display mode corresponding to the first wearing position, user requirements of the wearable device can be better met, thereby achieving the technical effect of improving user experience.

Those skilled in the art should realize that an embodiment may be provided as a method, a system or a computer program product. Therefore, various embodiments may use forms of a full hardware embodiment, a full software embodiment, or an embodiment that is a combination of software and hardware. Furthermore, the embodiments may use forms of computer program products implemented on one or more computer storage media or device (including, but not limited, to a magnetic disk memory device, a CD-ROM device, an optical memory device or the like), which include a computer program code.

Various embodiments are described with reference to flow diagrams and/or block diagrams. It should be understood that each flow and/or block in the flow diagrams and/or block diagrams and a combination thereof may be implemented by computer program instructions. These computer program instructions may be provided for a processor or processors of programmable data processing device(s) to generate a machine, so as to generate an apparatus configured to implement designated functions in one or more flows of a flow diagram and/or one or more blocks of a block diagram by instructions, executed by a processor.

These computer program instructions may also be stored in a computer-readable storage device such as a computer or wearable device memory that can guide a computer or other programmable data processing device(s) to work in a particular way, so that the instructions stored in the computer-readable storage device or memory generate a manufactured product including instructions that implement the designated functions in one or more flows of a flow diagram and/or one or more blocks of a block diagram. In the context of this document, a computer-readable memory or storage device is not a signal and “non-transitory” includes all media except signal media.

The computer program instructions may also be loaded on a computer or other programmable data processing devices, to execute a series of operating steps on the computer or other programmable device(s) to produce a computer executed process, so that instructions executed on the computer or other programmable device(s) provide steps that implement designated functions in one or more flows of a flow diagram and/or one or more blocks of a block diagram.

Although example embodiments have been described, those skilled in the art may make additional alterations and modifications on these embodiments. Therefore, the appended claims are intended to be interpreted as covering the example embodiments, including equivalents and all alterations and modifications falling within the ability of those having skill in the art.

It will be apparent to those skilled in the art that various modifications and variations can be made to the example embodiments without departing from the spirit and scope of the disclosure. In view of the foregoing, the non-limiting example embodiments are to be construed as covering modifications and variations thereof.

1. A method, comprising:
detecting a first wearing position of a wearable device worn on the body of a user, wherein the wearable device provides one or more first functions corresponding to the first wearing position as well as one or more second functions corresponding to a different second wearing position of the wearable device on the body of the user;
determining the one or more first functions of the wearable device corresponding to the first wearing position based on the first wearing position; and
activating at least one of the first functions of the wearable device in response to detecting the wearable device is worn in the first wearing position.

2. The method according to claim 1, wherein the detecting of the first wearing position comprises:
acquiring at least one sensor parameter through a sensor of the wearable device; and
analyzing the at least one sensor parameter to obtain the first wearing position of the wearable device.

3. The method according to claim 1, further comprising, after activating at least one of the first functions, sending a request to a first electronic device connected to the wearable device to perform a processing procedure corresponding to at least one of the first functions.

4. The method according to claim 1, further comprising, after detecting the first wearing position of the wearable device, determining a first working frequency of a processor of the wearable device corresponding to the first wearing position based on a corresponding relationship between wearing positions and working frequencies of the processor of the wearable device; and
adjusting a working frequency of the processor to the first working frequency.

5. The method according to claim 1, further comprising:
determining at least one sensor corresponding to the first wearing position from sensors of the wearable device; and
enabling the at least one sensor and disabling other sensors.

6. The method according to claim 1, further comprising:
disabling functions in the wearable device except for at least one of the first functions.

7. The method according to claim 1, further comprising:
determining at least one input operation and at least one corresponding response instruction for the wearable device based on the first wearing position.

8. The method according to claim 1, further comprising:
determining a first display mode corresponding to the first wearing position based on the first wearing position.

9. The method according to claim 1, further comprising:
determining a first processing mode, wherein the first processing mode comprises an input parameter and a processing procedure.

10. A wearable device, comprising:
a casing;
a sensor, disposed in the casing; and
a processor, disposed in the casing and connected to the sensor, wherein the processor:
detects a first wearing position of the wearable device worn on the body of a user, wherein the wearable device provides one or more first functions corresponding to the first wearing position as well as one or more second functions corresponding to a different second wearing position of the wearable device on the body of the user;
determines the one or more first functions corresponding to the first wearing position based on the first wearing position; and
activates at least one of the first functions of the wearable device in response to the first wearing position being detected.

11. The wearable device according to claim 10, wherein the processor detects the first wearing position by acquiring at least one sensor parameter through a sensor of the wearable device; and analyzes the at least one sensor parameter to obtain the first wearing position of the wearable device.

12. The wearable device according to claim 10, wherein the processor, after activating at least one of the first functions, sends a request to a first electronic device connected to the wearable device to perform a processing procedure corresponding to at least one of the first functions.

13. The wearable device according to claim 10, wherein the processor, after detecting the first wearing position of the wearable device, determines a first working frequency of a processor of the wearable device corresponding to the first wearing position based on a corresponding relationship between wearing positions and working frequencies of the processor of the wearable device; and adjusts a working frequency of the processor to the first working frequency.

14. The wearable device according to claim 10, wherein the processor:
determines at least one sensor corresponding to the first wearing position from sensors of the wearable device; and
enables the at least one sensor.

15. The wearable device according to claim 14, wherein the processor disables other sensors.

16. The wearable device according to claim 10, wherein the processor:
disables functions in the wearable device except for at least one of the first functions.

17. The wearable device according to claim 10, wherein the processor:
determines at least one input operation and at least one corresponding response instruction for the wearable device based on the first wearing position.

18. The wearable device according to claim 10, wherein the processor:
determines a first display mode corresponding to the first wearing position based on the first wearing position.

19. The wearable device according to claim 10, wherein the processor:
determines a first processing mode, wherein the first processing mode comprises an input parameter and a processing procedure.

20. A method, comprising:
detecting a first wearing position of a wearable device from among a plurality of predetermined wearing position settings of the wearable device, wherein the wearable device provides one or more first functions corresponding to the first wearing position as well as one or more second functions corresponding to a different second wearing position of the wearable device on the body of the user;
activating, using a processor of the wearable device, the one or more first functions in response to the first wearing position being detected;
detecting the second wearing position of the wearable device from among the plurality of predetermined wearing position settings of the wearable device; and
changing, using the processor the wearable device, at least one of first functions to at least one of the second functions in response to the second wearing position being detected.
